(19) United States
(12) Patent Application Publication
(10) Pub. No.: US 2010/0023575 A1
(43) Pub. Date: Jan. 28, 2010

(54) PREDICTOR

(75) Inventors: Wee Boon Choo, Singapore (SG); Haibin Huang, Singapore (SG)

Correspondence Address: CHOATE, HALL & STEWART LLP, TWO INTERNATIONAL PLACE, BOSTON, MA, 02110, US

(73) Assignee: AGENCY FOR SCIENCE, TECHNOLOGY AND RESEARCH, Centros (SG)

(21) Appl. No.: 11/908,300

(22) PCT Filed: Mar. 9, 2006
(86) PCT No.: PCT/SG06/00049

§ 371 Date: Jul. 29, 2009

Related U.S. Application Data
(60) Provisional application No. 60/660,669, filed on Mar. 11, 2005.

(51) Int. Cl. G06F 7/52

(52) U.S. Cl. 708/607

(57) ABSTRACT

A Predictor is described which is based on a modified RLS (recursive least squares) algorithm. The modifications prevent divergence and accuracy problems when fixed point implementation is used.

The invention relates to predictors.

A lossless audio coder is an audio coder that generates an encoded audio signal from an original audio signal such that a corresponding audio decoder can generate an exact copy of the original audio signal from the encoded audio signal.

In course of the MPEG-4 standardisation works, a standard for audio lossless coding (ALS) is developed. Lossless audio coders typically comprise two parts: a linear predictor which, by reducing the correlation of the audio samples contained in the original audio signal, generates a residual signal from the original audio signal and an entropy coder which encodes the residual signal to form the encoded audio signal. The more correlation the predictor is able to reduce in generating the residual signal, the more compression of the original audio signal is achieved, i.e., the higher is the compression ratio of the encoded audio signal with respect to the original audio signal.

If the original audio signal is a stereo signal, i.e., contains audio samples for a first channel and a second channel, there are both intra-channel correlation, i.e., correlation between the audio samples of the same channel, and inter-channel correlation, i.e., correlation between the audio samples of different channels.

A linear predictor typically used in lossless audio coding is a predictor according to the RLS (recursive least squares) algorithm.

The classical RLS algorithm can be summarized as follows:

The algorithm is initialized by setting

P(0)=δI

wherein δ is a small positive constant, I is an M by M identity matrix where M is the predictor order.

Further, the M×1 weight vector W(n), defined as W(n)=[w₀(n), w₁(n), . . . w_{M-1}(n)]^{T}, is initialized by

W(0)=0

For each instant of time, n=1, 2, . . . , the following calculations are made:

V(n)=P(n−1)*X(n)

where X(n) is an input signal in the form of an M×1 matrix (i.e., an M-dimensional vector) defined as

X(n)=[x(n−1), . . . , x(n−M)]^{T}

(P(n) is an M by M matrix, and consequently, V(n) is an M by 1 matrix)

$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$

K(n) is an M by 1 matrix, λ is a positive value that is slightly smaller than 1, T is the transpose symbol, Tri denotes the operation to compute the upper (or lower) triangular part of the P(n) and to fill in the rest of the matrix by using the same values as in the upper (or lower) triangular part.

There are two problems with the above classical RLS algorithm for implementation using fixed point math.

Firstly, due to the limited dynamic range of fixed point, the variable m tends to round to zero easily. If m is zero, K(n) will be zero, P(n) will slowly increase depending on λ⁻¹ (slightly greater than 1) and will overflow eventually unless the input X(n) is changed in such a way that X^{T}V(n) is reduced (A high value of X^{T}V(n) leads to m being zero).

Secondly, the dynamic range of V(n) is very large (sometimes bigger than 2³²), and at the same time high accuracy is needed (at least 32 bit) to maintain high prediction gain. However, as the dynamic range of the variables used in the above equations are too large for most 32 bit fixed point implementation. So, there is a loss of accuracy when V(n) is coded using fixed point implementation similar to the other variables used in the algorithm.

An object of the invention is to solve the divergence problem and the accuracy problem arising when using the RLS algorithm with fixed point implementation.

The object is achieved by the predictors with the features according to the independent claims.

A Predictor used for calculating prediction values e(n) for a plurality of sample values x(n) wherein n is a time index, is provided, wherein

P(0)=δI is set wherein δ is a small positive constant, I is an M by M identity matrix where M is the predictor order and W(0)=0 is set;
and for each time index n=1, 2, . . . , the following calculations are made:

$$\underline{V} ( n ) = \underline{P} ( n - 1 ) * \underline{X} ( n ) where \underline{X} ( n ) = {[ x ( n - 1 ) , … , x ( n - M ) ]}^{T}$$

$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$

wherein K(n) is an M by 1 matrix (i.e. an M-dimensional vector), λ is a positive value that is slightly smaller than 1, T is the transpose symbol, Tri denotes the operation to compute the upper (or lower) triangular part of the P(n) and to fill in the rest of the matrix by using the same values as in the upper (or lower) triangular part;
and wherein further for each n it is determined whether m is lower than or equal to a predetermined value and if m is lower than or equal to the predetermined value P(n) is set to a predetermined matrix.

Further a Predictor used for calculating prediction values e(n) for a plurality of sample values x(n) wherein n is a time index, is provided, wherein

P(0)=δI is set wherein δ is a small positive constant, I is an M by M identity matrix where M is the predictor order and W(0)=0 is set;
and the following calculations are made for each time index n=1, 2, . . . :

$$\underline{V} ( n ) = \underline{P} ( n - 1 ) * \underline{X} ( n ) where \underline{X} ( n ) = {[ x ( n - 1 ) , … , x ( n - M ) ]}^{T}$$

$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$

wherein K(n) is an M by 1 matrix, A is a positive value that is slightly smaller than 1, T is the transpose symbol, Tri denotes the operation to compute the upper (or lower) triangular part of the P(n) and to fill in the rest of the matrix by using the same values as in the upper (or lower) triangular part and wherein further the variable V(n) is coded as the product of a scalar times a variable V′(n) the scalar is predetermined in such a way that V′(n) stays within a predetermined interval.

Illustratively, when the value m has become very small in one step of the prediction algorithm, P(n) is re-initialized. In this way, the system is kept stable since P(n) will not overflow.

Further, V(N) is scaled with a scalar, i.e. a scale factor, in the following denoted by vscale, such that V(N)=vscale*V′(N). In this way, the range of the scaled variable V′(N) is reduced compared to V(N). Therefore, there is no loss of accuracy when fixed point implementation is used for coding V′(N).

For example, according to the MPEG-4 ALS standard specification, P(0) may be initialized using the small constant 0.0001. In another embodiment, P(0)=δ⁻¹I is set wherein δ is a small positive constant.

Preferred embodiments of the invention emerge from the dependent claims.

In one embodiment the predetermined value is 0. The predetermined value may also be a small positive constant. The predetermined vector is for example P(0)=δI. The predetermined vector may also be P(0)=δ⁻¹Ī. In one embodiment, fixed point implementation is used for the calculations. In particular, in one embodiment V′(n) is coded using fixed point implementation.

Illustrative embodiments of the invention are explained below with reference to the drawings.

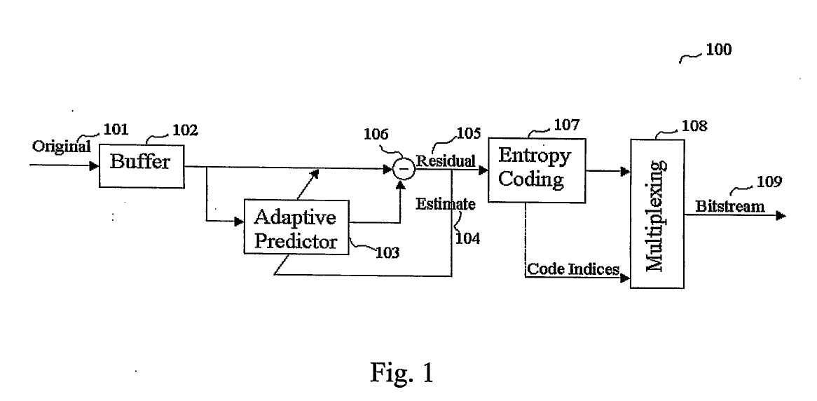

FIG. 1 shows an encoder according to an embodiment of the invention.

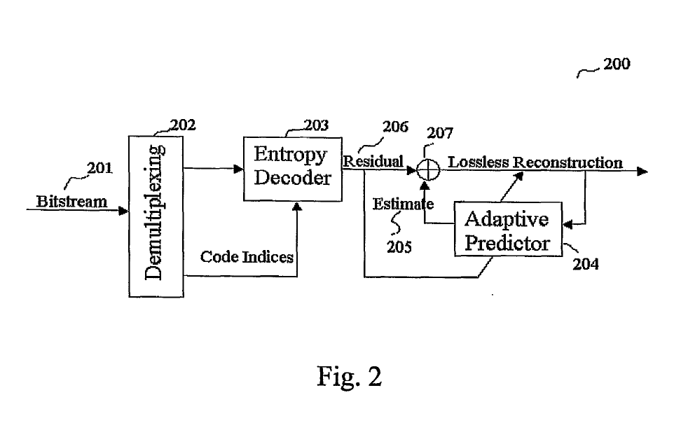

FIG. 2 shows a decoder according to an embodiment of the invention.

FIG. 1 shows an encoder 100 according to an embodiment of the invention.

The encoder 100 receives an original audio signal 101 as input.

The original audio signal consists of a plurality of frames. Each frame is divided into blocks, each block comprising a plurality of samples. The audio signal can comprise audio information for a plurality of audio channels. In this case, typically, a frame comprises a block for each channel, i.e., each block in a frame corresponds to a channel.

The original audio signal 101 is a digital audio signal and was for example generated by sampling an analogue audio signal at some sampling rate (e.g. 48 kHz, 96 KHz and 192 kHz) with some resolution per sample (e.g. 8 bit, 16 bit, 10 bit and 14 bit).

A buffer 102 is provided to store one frame, i.e., the audio information contained in one frame.

The original audio signal 101 is processed (i.e. all samples of the original signal 101 are processed) by an adaptive predictor 103 which calculates a prediction (estimate) 104 of a current sample value of a current (i.e. currently processed) sample of the original audio signal 101 from past sample values of past samples of the original audio signal 101. For this, the adaptive predictor 103 uses an adaptive algorithm. This process will be described below in detail.

The prediction 104 for the current sample value is subtracted from the current sample value to generate a current residual 105 by a subtraction unit 106.

The current residual 105 is then entropy coded by an entropy coder 107. The entropy coder 107 can for example perform a Rice coding or a BGMC (Block Gilbert-Moore Codes) coding.

The coded current residual, code indices specifying the coding of the current residual 105 performed by the entropy coder 107, the predictor coefficients used by the adaptive predictor used in generating the prediction 104 and optionally other information are multiplexed by a Multiplexer 108 such that, when all samples of the original signal 101 are processed, a bitstream 109 is formed which holds the losslessy coded original signal 101 and the information to decode it.

The encoder 100 might offer several compression levels with differing complexities for coding and compressing the original audio signal 101. However, the difference in terms of coding efficiency typically are rather small for high compression levels, so it may be appropriate to abstain from the highest compression in order to reduce the computational effort.

Typically, the bitstream 109 is transferred in some way, for example via a computer network, to a decoder which is explained in the following.

FIG. 2 shows a decoder 200 according to an embodiment of the invention.

The decoder 200 receives a bitstream 201, corresponding to the bitstream 109, as input.

Illustratively, the decoder 100 performs the reverse function of the encoder.

As explained, the bitstream 201 holds coded residuals, code indices and predictor coefficients. This information is demultiplexed from the bitstream 201 by a demultiplexer 202.

Using the respective code indices, a current (i.e. currently processed) coded residual is decoded by an entropy decoder 203 to form a current residual 206.

Since the sample values of the samples preceding the sample corresponding to the current residual 206 are assumed to have already been processed, an adaptive predictor 204 similar to the adaptive predictor 103 can generate a prediction 205 of the current sample value, i.e. the sample value to be losslessly reconstructed from the current residual 206, which prediction 205 is added to the current residual 206 by an adding unit 207.

The output of the adding unit 207 is the losslessly reconstructed current sample which is identical to the sample processed by the encoder 100 to form the current coded residual.

The computational effort of the decoder 200 depends on the order of the adaptive predictor 204, which is chosen by the encoder 100. Apart from the order of the adaptive predictor 204, the complexity of the decoder 200 is the same as the complexity of the encoder 100.

The encoder 100 does in one embodiment also provide a CRC (cyclic redundancy check) checksum, which is supplied to the decoder 200 in the bitstream 109 such that the decoder 200 is able to verify the decoded data. On the side of the encoder 100, the CRC checksum can be used to ensure that the compressed file is losslessly decodable.

In the following, the functionality of the adaptive predictor 103 according to one embodiment of the invention is explained.

The predictor is initialized by setting

P(0)=δI

wherein δ is a small positive constant, I is an M by M identity matrix where M is the predictor order.

Further, the M×1 weight vector W(n), defined as W(n)=[w₀(n), w₁(n) . . . w_{M-1}(n)] T, which is illustratively the vector of the initial filter weights is initialized by

W(0)=0

For each instant of time, i.e. for each sample value x(n) to be processed by the predictor, wherein n=1, 2, . . . is the corresponding time index, the following calculations are made:

V(n)=P(n−1)*X(n)

where X(n) is an input signal in the form of an M×1 matrix defined as

X(n)=[x(n−1), . . . , x(n−M)]^{T}

(P(n) is an M by M matrix, consequently, V(n) is an M by 1 matrix)

The vector X(n) is the vector of sample values preceding the current sample value x(n). Illustratively, the vector X(n) holds the past values which are used to predict the present value.

$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$

K(n) is an M by 1 matrix, λ is a positive value that is slightly smaller than 1, T is the transpose symbol (i.e. denotes the transposition operation), Tri denotes the operation to compute the upper (or lower) triangular part of the P(n) and to fill in the rest of the matrix by using the same values as in the upper (or lower) triangular part.

To prevent the divergence problem arising from the fact that m may be rounded to zero, in each step it is tested if m is zero. If this is the case, P(n) is re-initialized, for example according to

P(n)=δI.

To solve the problem of the accuracy loss resulting form the fact that the variables, in particular V(n) is coded in fixed point format, a scale factor vscale is introduced.

The scale factor vscale is critically chosen to use with V(n). The scale factor vscale enables the other variables to be simply represented in 32 bits forms with a shifted parameter related vscale. In this way, the algorithm can operate mostly with 32 bits fixed point operations rather than emulating floating point math operation.

V(n) is coded as the product of vscale and a variable V′(n). vscale is chosen such that V′(n) can be coded in fixed point format without loss (or with little loss) of accuracy, for example compared to a floating point implementation.

1. Predictor used for calculating prediction values e(n) for a plurality of sample values x(n) wherein n is a time index, wherein
P(0)=δI is set wherein δ is a small positive constant, I is an M by M identity matrix where M is the predictor order and W(0)=0 is set;
and for each time index n=1, 2, . . . , the following calculations are made:
$$\underline{V} ( n ) = \underline{P} ( n - 1 ) * \underline{X} ( n ) where \underline{X} ( n ) = {[ x ( n - 1 ) , … , x ( n - M ) ]}^{T}$$
$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$
wherein K(n) is an M by 1 matrix, λ is a positive value that is slightly smaller than 1, T is the transpose symbol, Tri denotes the operation to compute the upper (or lower) triangular part of the P(n) and to fill in the rest of the matrix by using the same values as in the upper (or lower) triangular part;
and wherein further
for each n it is determined whether m is lower than or equal to a predetermined value;
if m is lower than or equal to the predetermined value P(n) is set to a predetermined matrix.

2. Predictor according to claim 1, wherein the predetermined value is a small positive constant.

3. Predictor according to claim 1, wherein the predetermined vector is δI.

4. Predictor according to claim 1, wherein fixed point implementation is used for the calculations.

5. Predictor used for calculating prediction values e(n) for a plurality of sample values x(n) wherein n is a time index, wherein
P(0)=δI is set wherein δ is a small positive constant, I is an M by M identity matrix where M is the predictor order and W(0)=0 is set;
and the following calculations are made for each time index n=1, 2,
$$\underline{V} ( n ) = \underline{P} ( n - 1 ) * \underline{X} ( n ) where \underline{X} ( n ) = {[ x ( n - 1 ) , … , x ( n - M ) ]}^{T}$$
$$m = \{ \begin{matrix}\frac{1}{{\underline{X} ( n )}^{T} \underline{V} ( n )} & if {\underline{X}}^{T} \underline{V} ( n ) \neq 0 \\ 1 & else .\end{matrix} \\ \underline{K} ( n ) = m * \underline{V} ( n ) \\ e ( n ) = x ( n ) - {\underline{W}}^{T} ( n - 1 ) \underline{X} ( n ) \\ \underline{W} ( n ) = \underline{W} ( n - 1 ) + \underline{K} ( n ) e ( n ) \\ \underline{P} ( n ) = Tri \{ {λ}^{- 1} [ \underline{P} ( n - 1 ) - \underline{K} ( n ) * {\underline{V}}^{T} ( n ) ] \}$$
wherein K(n) is an M by 1 matrix, λ is a positive value that is slightly smaller than 1, T is the transpose symbol, Tri denotes the operation to compute the upper (or lower) triangular part of the P(n) and to fill in the rest of the matrix by using the same values as in the upper (or lower) triangular part;
and wherein further
the variable V(n) is coded as the product of a scalar times a variable V′(n)
the scalar is predetermined in such a way that V′(n) stays within a predetermined interval.

6. Predictor according to claim 5, wherein the variable V′(n) is coded using fixed point implementation.

7. Predictor according to claim 2, wherein the predetermined vector is δI.

8. Predictor according to claim 2, wherein fixed point implementation is used for the calculations.

9. Predictor according to claim 3, wherein fixed point implementation is used for the calculations.
